(19) United States
(12) Patent Application Publication
(10) Pub. No.: US 2026/0278716 A1
(43) Pub. Date: Sep. 17, 2026

(54) SYSTEM AND METHOD FOR CONTEXT-BASED LIFE PLANNING INTERACTIONS

(71) Applicant: Wells Fargo Bank, N.A., San Francisco, CA (US)

(72) Inventors: Huanchee Chan, Fort Mill, SC (US); Kourtney Eidam, Marieta, GA (US); Carrie Anne Hanson, Charlotte, NC (US); Brian M. McMillen, Davidson, NC (US); Gurudatta Pai, Matthews, NC (US)

(21) Appl. No.: 18/050,766

(22) Filed: Oct. 28, 2022

(51) Int. Cl. G06Q 50/18; G06Q 40/06

(52) U.S. Cl. CPC G06Q 50/186; G06Q 40/06

(57) ABSTRACT

Various examples are directed to computer-implemented systems and methods for context-based life planning interactions. A method includes receiving information related to events that may implicate estate transfer, and automatically identifying one or more potentially life-threatening events using machine learning based on the information. A casualty score is generated for the one or more potentially life-threatening events and one or more potentially impacted individuals of the one or more potentially life-threatening events are automatically identified using the machine learning. An impact likelihood score is generated for the one or more potentially impacted individuals, and the one or more potentially impacted individuals are categorized into an impact category based on the impact likelihood score. Estate transfer related action items are automatically generated for a financial institution advisor of the one or more potentially impacted individuals based on one or more of the impact likelihood score, the casualty score or the impact category.

### TECHNICAL FIELD

This document relates generally to computer systems and more particularly to systems and methods for context-based life planning interactions.

### BACKGROUND

Financial institutions associated with at least a portion of an estate transfer of a recently deceased individual are tasked with various operations associated with the individual's estate. However, the financial institutions may be unaware of an individual's passing unless informed by a family member or the like and as such, may result in a delay in the beginning the estate transfer process. Additionally, financial institution agents, though unintended, may come off as insensitive when reaching out to an individual in mourning concerning an estate transfer or other similar matter, especially if the cause of death is unusual and/or unexpected. As such, there is a need for an event identification and planning system capable of proactively recognizing events that may implicate estate transfer.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1A illustrates an example embodiment of a method for context-based life planning interactions, according to various embodiments;

FIG. 1B illustrates an example embodiment of a method for using a context-based life planning tool, according to various embodiments;

FIG. 2 illustrates an exemplary infrastructure for use in the present subject matter, according to various embodiments;

FIG. 3 illustrates an example machine learning module for a context-based life planning tool, according to various embodiments;

FIG. 4 illustrates a flowchart of a method of training a model for a context-based life planning tool, according to various embodiments; and

FIG. 5 is a block diagram of a machine in the example form of a computer system within which a set of instructions may be executed, for causing the machine to perform any one or more of the methodologies discussed herein.

### DETAILED DESCRIPTION

Financial institutions associated with at least a portion of an estate transfer of a recently deceased individual are tasked with various operations associated with the individual's estate. However, the financial institutions may be unaware of an individual's passing unless informed by a family member or the like and as such, may result in a delay in the beginning the estate transfer process. Additionally, financial institution agents, though unintended, may come off as insensitive when reaching out to an individual in mourning concerning an estate transfer or other similar matter, especially if the cause of death is unusual and/or unexpected. As such, there is a need for an event identification and planning system capable of proactively recognizing events that may implicate estate transfer.

The present subject matter provides a context-based event identification and planning system that provides a technical solution to the above problems, by using machine learning and/or artificial intelligence (AI) to automatically identify potentially life-threatening events and individuals impacted by such events. Further, the system may assist a financial institution or other business in more promptly and appropriately communicating with customers or users that have been identified as impacted, or are related in some manner to those customers that have been identified as impacted.

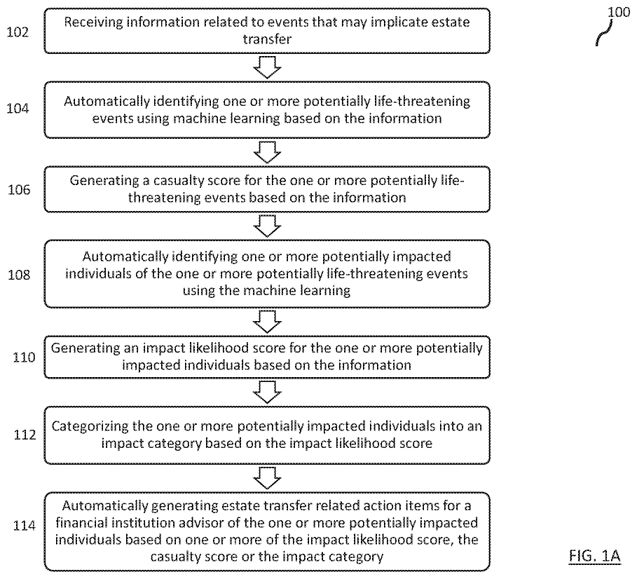

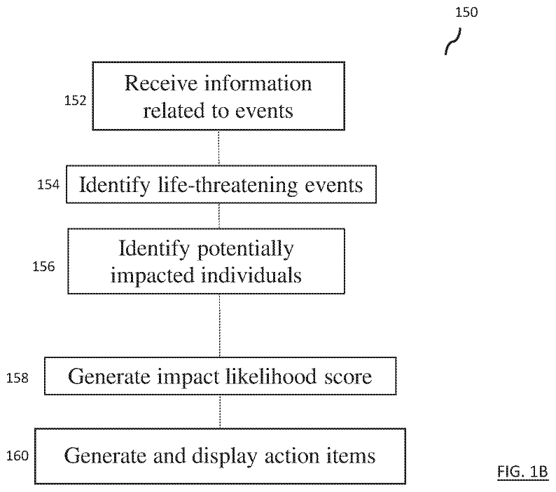

FIG. 1A illustrates an example embodiment of a method for context-based life planning interactions, according to various embodiments. The method 100 includes receiving, by a computer system, information related to events that may implicate estate transfer, at step 102. In various examples, receiving information related to events includes receiving one or more documents and identifying one or more critical terms contained within the one or more documents. At step 104, the method 100 includes automatically identifying, by the computer system, one or more potentially life-threatening events using machine learning based on the information. The event identification machine learning model may be an AI network or a neural network, such as a long short-term memory (LSTM) network or bidirectional encoder representations from transformers (BERT), in some examples. The method 100 includes generating, by the computer system, a casualty score for the one or more potentially life-threatening events based on the information, at step 106. The casualty score may be indicative of the likelihood of a fatality for an individual involved in the event, in various examples.

At step 108, the method 100 includes automatically identifying, by the computer system, one or more potentially impacted individuals of the one or more potentially life-threatening events using the machine learning. In some examples, an impacted individual machine learning model may be configured to identify one or more potentially impacted individuals, which may be associated with a financial institution. The method 100 includes generating, by the computer system, an impact likelihood score for the one or more potentially impacted individuals based on the information, at step 110. The impact likelihood score for the individual may be indicative of the likelihood the individual was impacted by the event, in various examples. At step 112, the method 100 includes categorizing, by the computer system, the one or more potentially impacted individuals into an impact category based on the impact likelihood score. In various examples, an optional impacted individual verification machine learning model may be configured to categorize the potentially impacted individual into an impact category (e.g., decease verified category or decease not verified category).

The method 100 includes automatically generating, by the computer system, estate transfer related action items for a financial institution advisor of the one or more potentially impacted individuals based on one or more of the impact likelihood score, the casualty score or the impact category, at step 114. The event identification and planning system may automatically generate estate transfer related action items for financial institution advisors to perform if the impact likelihood score for the individual is determined to satisfy one or more impact likelihood score thresholds and/or the aggregated casualty score for the event is determined to satisfy one or more aggregated casualty score thresholds, or the potentially impacted individual is categorized in the decease verified category, in various examples.

According to various embodiments, automatically generating estate transfer related action items is based on the impact likelihood score satisfying one or more impact likelihood score thresholds. Automatically generating estate transfer related action items is based on calculating an aggregated casualty score for the one or more potentially life-threatening events, and wherein the aggregated casualty score for the one or more potentially life-threatening events is determined to satisfy one or more aggregated casualty score thresholds, in various embodiments. In various examples, the impact category may include a decease verified category. The impact category may include a decease non-verified category, in various examples. Other impact categories may be used without departing from the scope of the present subject matter. In some examples, automatically generating estate transfer related action items may be based on the potentially impacted individual being categorized in the decease verified category.

The method may further include automatically generating, by the computer system, a recommended script for the financial institution advisor to use with users associated with the impacted individual, in some embodiments. In various examples, automatically generating the recommended script includes using a rule-based configuration. The rule-based configuration may use one or more of a severity level, the impact likelihood score, a relationship of the contacted individual to the impacted individual, the casualty score or the impact category as inputs to generate the recommended script. Other inputs may be used without departing from the scope of the present subject matter. In one example, when the impacted individual is categorized in the decease verified category, the recommended script includes context surrounding death of the impacted individual to enable the financial institution advisor to be better informed when contacting appropriate parties. The method may also include determining, by the computer system, other impacted users associated with the impacted individual, and storing, by the computer system an alert or the recommended script in a profile of each of the other impacted users, in various embodiments.

FIG. 1B illustrates an example embodiment of a method for using a context-based life planning tool, according to various embodiments. According to various embodiments, the method 150 includes receiving information related to events, at step 152. In various examples, receiving the information includes receiving news articles, social media data, or other third-party data. At step 154, the method 150 includes identifying life-threatening events. Identifying the life-threatening events may include using machine learning, in various examples. The method 150 includes identifying potentially impacted individuals, at step 156. Identifying the potentially impacted individuals of life-threatening events may include using machine learning, in various examples. At step 158, the method 150 includes generating an impact likelihood score. The impact likelihood score for the individual may be indicative of the likelihood the individual was impacted by the event, in various examples. The method 150 includes generating and displaying action items, at step 160. In various examples, the action items may include a recommended script that provides context surrounding the death of the impacted individual to enable a financial institution advisor to be better informed when contacting appropriate parties. In various examples, the recommended script may be generated using a rule-based configuration. The rule-based configuration may use one or more of a severity level, an impact likelihood score, a casualty score or an impact category as inputs to generate the recommended script.

The present event identification and planning system may identify potential life-threatening events (e.g., vehicle accidents, natural disaster, mass shootings, etc.) and generate a list of one or more potentially impacted individuals. In particular, the event identification and planning system may use an event planning machine learning framework to identify the potentially life-threatening events and generate a list of the one or more impacted individuals. The event planning machine learning framework may include an event identification machine learning model which is configured to process various input documents (e.g., news articles, social media data, or other third-party data) to identify one or more potential casualty events.

The event identification machine learning model may further be configured to generate a casualty score for the event, indicative of the likelihood of a fatality for an individual involved in the event. The event identification machine learning model may be a neural network, such as a long short-term memory (LSTM) network or bidirectional encoder representations from transformers (BERT), configured to identify one or more critical terms contained within each document and determine an overall casualty score for the document based at least in part on the critical terms and/or their associated sequence. For example, a document only containing the critical term “hurricane” may have a lower overall casualty score than a document containing the critical term “hurricane” found to be nearby (e.g., within n words from) the term “category 5”. As another example, a document only containing the critical term “hurricane” may have a higher overall casualty score than a document containing the critical terms “hurricane” and “category 2” due to the vagueness of the term “hurricane”. The event identification machine learning model may be configured to determine an aggregated casualty score for the event based on each document identified as associated with the event. Documents may be weighted based on their robustness as well as the trustworthiness of the source for the document.

The event planning machine learning framework may also include an impacted individual machine learning model configured to identify one or more potentially impacted individuals, which may be associated with the financial institution or business. The impacted individual machine learning model may be a neural network, such as an LSTM, configured to identify individuals involved in the potentially life threatening event and generating an impact likelihood score. For example, the impacted individual model may process documents indicative of the event to identify an individual's name and/or contextual data and/or may use user data associated with a user profile (e.g., address or other geographic information) and/or social media data to identify a potentially impacted individual and determine an impact likelihood score for the individual, indicative of the likelihood the individual was impacted by the event.

The event planning machine learning framework may also include an optional impacted individual verification machine learning model configured to categorize the potentially impacted individual into an impact category (e.g., decease verified category or decease not verified category). The impacted individual verification machine learning model may be configured to match identification data of a potentially impacted individual to a death verification record (e.g., a death record) as stored in a third-party database (e.g., the National Death Index (NDI)). Additionally, or alternatively, if a document affirmatively indicates the death of the individual (e.g., lists the individual as deceased etc.), the impacted individual verification machine learning model may classify the individual in the decease verified category. If the impacted individual verification machine learning model determines an affirmative match of the potentially impacted individual, the potentially impacted individual may be categorized in the decease verified category. Otherwise, the potentially impacted individual may be categorized in the decease non-verified category.

The event identification and planning system may automatically generate estate transfer related action items for financial institution advisors to perform in the instance (i) the impact likelihood score for the individual are determined to satisfy one or more impact likelihood score thresholds and/or the aggregated casualty score for the event is determined to satisfy one or more aggregated casualty score thresholds or (ii) the potentially impacted individual is categorized in the decease verified category. The event planning machine learning framework may further include a recommendation machine learning model configured to generate a recommended script for the financial institution agent to use with users associated with the impacted individual. The recommended script may be automatically generated using a weighted rule-based configuration and indicate the context surrounding the death of the impacted individual and the user's relationship to the impacted individual to enable the financial institution advisor to be better informed when contacting appropriate parties.

The event identification and planning system may utilize an AI-based knowledge tree to determine other impacted users associated with the impacted individual and may store an alert and/or the recommended script in each associated user's profile such that the financial institution agent may be made aware of the association. As such, if a point of contact is determined to likely be involved in the event, the event identification and planning system may select a next appropriate point of contact.

Various embodiments include a computing system with one or more processors and a data storage system in communication with the one or more processors, wherein the data storage system comprises instructions thereon that, when executed by the one or more processors, causes the one or more processors to execute the steps of the methods of FIGS. 1A-1B. In some examples, the machine learning may include a machine learning model including a neural network. The machine learning model may include one or more of a long short-term memory (LSTM) network, bidirectional encoder representations from transformers (BERT), natural language processing (NLP), or an artificial intelligence (AI)-based knowledge tree, in various examples. Other types of machine learning models may be used without departing from the scope of the present subject matter.

Various embodiments include a non-transitory computer-readable storage medium, the non-transitory computer-readable storage medium including instructions that, when executed by computers, cause the computers to perform operations including the methods of FIGS. 1A-1B. In various examples, receiving information related to events includes receiving one or more documents. One or more critical terms contained within the one or more documents may be identified, and an overall casualty score may be determined for the one or more documents based at least in part on the one or more critical terms, or a sequence of the one or more critical terms, in various examples.

The present system may be used to assist in estate transfers and planning, in various examples, and may be used to further enable persons engaged in the financial affairs of a user or customer to better communicate with a user or customer's family in time of mourning by proactively recognizing events that may impact the lives of the user or customer's family. In various embodiments, the present system uses AI, such as a combination of machine learning and natural language processing (NLP) to trigger notifications and alerts based on identified life-threatening events, such as natural disasters. For example, the system may utilize an AI-based knowledge tree to connect various parties to the individual. Additionally, the system may use NLP or similar technology to automatically generate scripts for a financial advisor based on the event. In various examples, automatically generating the recommended script includes using a weighted rule-based configuration. The rule-based configuration may use one or more of an impact likelihood score, a severity level, a casualty score, a relationship of the contacted individual to the impacted individual, or an impact category as inputs to generate the recommended script. The scripts may aid the financial advisor in speaking to family members in a more sensitive manner. The system may also generate estate transfer-related action items for a financial advisor to perform in the event that a customer is identified as being a victim in a catastrophic event.

An example system of the present subject matter may use an AI model or the like to identify potential life-threatening events (e.g., vehicle accidents, natural disasters, mass shootings, etc.) and determine whether customers of a financial institution were involved and/or are among the deceased. If a customer or beneficiary is implicated in the event, the system may automatically perform proactive measures related to estate planning, in various examples. As one example, the system may trigger notifications to financial advisors associated with the individual and/or beneficiaries of the individual based on stored estate planning records. The proactive measures may include providing one or more financial advisors with information regarding the context of the death to enable the advisor to be better informed when reaching out to relatives or other associates of the individual. As another example, if a beneficiary is implicated in the same event as the customer, the system may identify that fact and update its notification plan accordingly.

In one example, the present system provides for estimating a casualty level of the event based on the processing of each document determined to be related to the event using identified key words from identified relevant documents. In various examples, the present system provides for estimating a severity score for the event based on the documents. According to various embodiments, the present system provides for generating an impact likelihood score for an individual indicative of the likelihood that the individual was involved in the event, determining an estimated impact score for the individual, and using either a document or third-party sources to verify the decease of the individual in an instance the estimated impact score satisfies one or more impact score thresholds.

In some examples, if a tornado is to impact a geographical area, and a business knows the address of customers in the area, the present system can make predictions on the impact on a macro level, and on a micro level for each customer. Also, known customer habits may be used to make predictions. For example, if a first customer is online shopping or usually home on a given day, they are more likely to be impacted than a second customer that is usually at work on the given day.

In various embodiments, if a customer of a business is in an automobile accident and the business knows the make and model of the customer's automobile (for example, if the business is the financial institution that provided a loan for the automobile), the present system may use AI to determine the safety level of the automobile and further predict a severity level of the accident. In some examples, the predicted severity level can be used by the system to trigger different types/levels of notification. For example, if a customer is predicted or determined to be a casualty of the event, the system may notify a financial planner or attorney of the customer to initiate estate planning. If the customer is predicted or determined to be injured by the event, the system may notify or trigger contact with a power of attorney or relative (such as a spouse) of the customer regarding financial needs of the customer, in an embodiment. In one example, if spouses were both predicted or determined to be injured by the event, the system may trigger notification of a next delegate or beneficiary of the customer.

In various embodiments, the present system may queue up actions and scripts for a business representative, such as a financial advisor, to determine the content and timing of interactions with the customer or the customer's representatives based on a predicted severity level. In one example, the present system may trigger other services if the customer is predicted or determined to be incapacitated or mildly effected. For example, the system may notify a representative of the customer's automobile insurer or automobile purchasing lender to contact the customer a certain time after an accident. In various examples, the present system may prompt a financial advisor to try to contact the customer to check on their condition, such as by using a push notification. The notification may prompt the customer to answer or respond to confirm if the customer was affected and to what level they were affected, and if the customer does not respond, the system may attempt to contact the next identified delegate or beneficiary of the customer, and so on.

In one example, if a disaster affects a location of a business, the system may identify customers that normally go to that location on certain days, and notify customers or notify business representatives that may contact customers, to inform the customer and/or to direct the customer to another location of the business. For example, if the business is a financial institution, customers may not be able to make deposits if their branch is closed. The system may identify affected customers based on usage by customers, residence by customers within a predetermined radius of the location, or customers that established accounts at the location, in various examples. Business representatives may be prompted at a display to initiate contact with affected or potentially affected customers, such as for relationship building, in various embodiments.

According to various embodiments, if the present system determines that a customer has deceased, the system notifies an estate transfer representative to contact the customer's family or beneficiary in a timely manner, and may provide a script for the representative to assist in communicating with and guiding the contacted persons. The present system may use internal data or knowledge of the customer, such as records of transactions and accounts, as well as external data, such as casualty data or news media documents, to make predictions and generate scripts, in various embodiments. The present system may process a variety of information, data and/or documents to obtain information including, but not limited to, names and addresses, hometowns, population density, general disaster information (e.g., category of storms for severity analysis), automobile safety levels, account data, transactional data (e.g., airline ticket purchase records in event of airline crash), and the like. Other types of information may be used without departing from the scope of the present subject matter. In various embodiments, the present system may scrape relevant keywords from articles, such as small plane, large plane, number of casualties, weather notifications, and the like.

In various embodiments, the present system may use information regarding past similar events (events in similar geographic areas, for example) to predict the likelihood and severity of reoccurring events, and use the predictions to anticipate, warn and proactively notify potentially affected individuals. In some embodiments, the present system includes a user interface (UI) with a display and input capabilities, that may provide for a business representative or other user to enter an event that should be processed and evaluated by the present system. The UI may be used to notify and inform business representatives of affected customers and scripts to initiate contact with affected customers or their relatives or other designated representatives, in various embodiments. In some examples, the business representatives may share data and predictions with other commercial partners, service providers or contractors. For example, if an affected customer has accounts in other banks, the system may share information with the other banks if there is an agreement with the other banks or service providers.

In various examples, the present system may use micro-level data and macro-level data to identify events and customers affected by the events. In one example, if the system determines that a customer purchased coffee at a location that was impacted by an event at or near the time of the event, the system may predict the customer was affected by the event and initiate contact with the customer (and subsequently initiate contact with the delegate of the customer if the customer does not respond) to attempt to confirm the prediction. According to various embodiments, the present system may include a sign-up or opt-in feature for customers, such as during estate planning or account opening. In some examples, during the sign-up procedure the customer may authorize the business to contact the customer, customer delegate, and/or first responder based on predictions by the present system. In various examples, a representative of the business will initiate contact using a script prepared by the system based on or weighted by a determined severity level of the event or other event-related parameter using a rule-based configuration. The initiated contact may be directed to different individuals based on the determined severity level of the event, in various examples. In various embodiments, the present system runs simulations to train the machine learning models, and to identify process improvements and optimization from simulated events. Training of the models may be accomplished online or offline, in various embodiments.

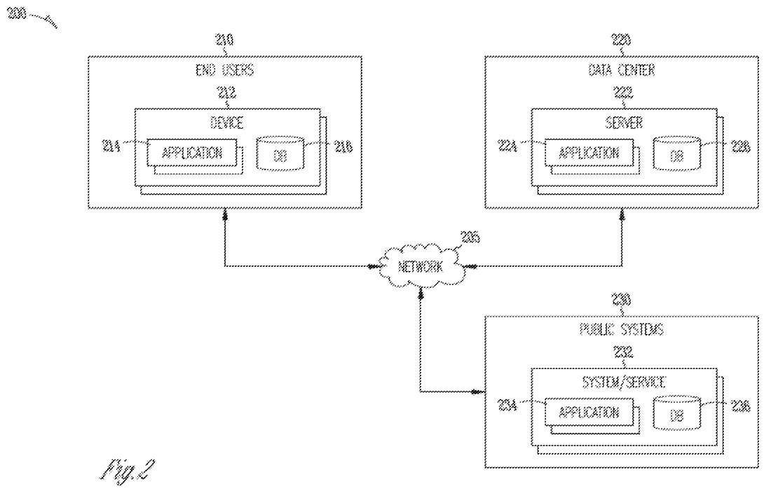

FIG. 2 illustrates an exemplary infrastructure for providing a system of the present subject matter. The infrastructure may comprise a distributed system 200 that may include a client-server architecture or cloud computing system. Distributed system 200 may have one or more end users 210. An end user 210 may have various computing devices 212, which may be a machine 500 as described below. The end-user computing devices 212 may comprise applications 214 that are either designed to execute in a stand-alone manner, or interact with other applications 214 located on the device 212 or accessible via the network 205. These devices 212 may also comprise a data store 216 that holds data locally, the data being potentially accessible by the local applications 214 or by remote applications.

The system 200 may also include one or more data centers 220. A data center 220 may be a server 222 or the like associated with a business entity that an end user 210 may interact with. The business entity may be a computer service provider, as may be the case for a cloud services provider, or it may be a consumer product or service provider, such as a retailer. The data center 220 may comprise one or more applications 224 and databases 226 that are designed to interface with the applications 214 and databases 216 of end-user devices 212. Data centers 220 may represent facilities in different geographic locations where the servers 222 may be located. Each of the servers 222 may be in the form of a machine(s) 500.

The system 200 may also include publicly available systems 230 that comprise various systems or services 232, including applications 234 and their respective databases 236. Such applications 234 may include news and other information feeds, search engines, social media applications, and the like. The systems or services 232 may be provided as comprising a machine(s) 500.

The end-user devices 212, data center servers 222, and public systems or services 232 may be configured to connect with each other via the network 205, and access to the network by machines may be made via a common connection point or different connection points, e.g., a wireless connection point and a wired connection. Any combination of common or different connections points may be present, and any combination of wired and wireless connection points may be present as well. The network 205, end users 210, data centers 220, and public systems 230 may include network hardware such as routers, switches, load balancers and/or other network devices.

Other implementations of the system 200 are also possible. For example, devices other than the client devices 212 and servers 222 shown may be included in the system 200. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 222.

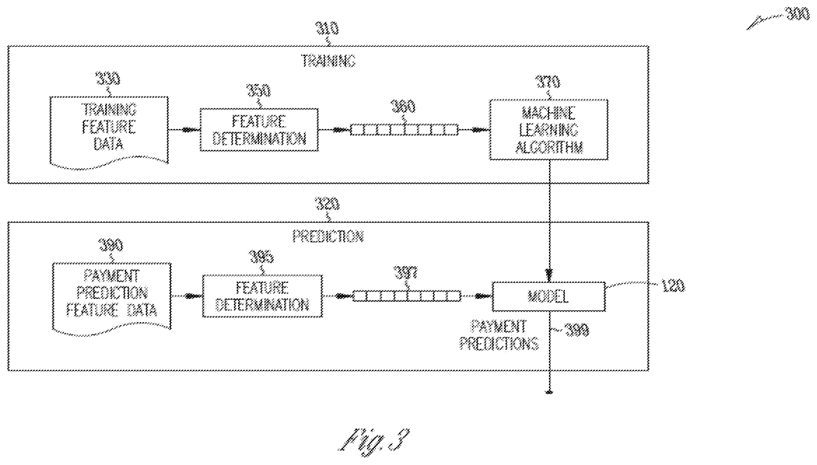

FIG. 3 shows an example machine learning module 300 according to some examples of the present disclosure. The machine learning module 300 may be implemented in whole or in part by one or more computing devices. In some examples, the training module 310 may be implemented by a different device than the prediction module 320. In these examples, the model 120 may be created on a first machine and then sent to a second machine.

Machine learning module 300 utilizes a training module 310 and a prediction module 320. Training module 310 inputs training feature data 330 into feature determination module 350. The training feature data 330 may include data determined to be predictive of identifying a life-threatening event or a potentially impacted individual of a life-threatening event. Categories of training feature data may include news articles, social media data, other third-party data, or the like. In some examples, transaction history over a past time period (e.g., 12 months), expenditure details, and the like may be used to identify potentially impacted individuals that are customers of a financial institution. In some examples, the financial history of the user may only utilize financial history of the account that is created by the user, but in other examples, other account history of other accounts (e.g., checking, savings, and the like) may also be used. For example, a history of deposits into a checking or savings account may be used.

Specific training feature data and prediction feature data 390 may include, for example one or more of: personal financial history of the user; geographic location of user's branch of the financial institution; and the like.

Feature determination module 350 selects training vector 360 from the training feature data 330. The selected data may fill training vector 360 and comprises a set of the training feature data that is determined to be predictive of a life-threatening event or a potentially impacted individual. In some examples, the tasks performed by the feature determination module 350 may be performed by the machine learning algorithm 370 as part of the learning process. Feature determination module 350 may remove one or more features that are not predictive of a life-threatening event or a potentially impacted individual prior to training the model 120. This may produce a more accurate model that may converge faster. Information chosen for inclusion in the training vector 360 may be all the training feature data 330 or in some examples, may be a subset of all the training feature data 330.

In other examples, the feature determination module 350 may perform one or more data standardization, cleanup, or other tasks such as encoding non numerical features. For example, for categorical feature data, the feature determination module 350 may convert these features to numbers. In some examples, encodings such as “One Hot Encoding” may be used to convert the categorical feature data to numbers. This enables a representation of the categorical variables as binary vectors and provided a “probability-like” number for each label value to give the model more expressive power. One hot encoding represents a category as a vector whereby each possible category value is represented by one element in the vector. When the data is equal to that category value, the value of the vector is a ‘1’ and all other elements are zero (or vice versa).

The training vector 360 may be utilized (along with any applicable labels) by the machine learning algorithm 370 to produce a model 120. In some examples, other data structures other than vectors may be used. The machine learning algorithm 370 may learn one or more layers of a model. Example layers may include convolutional layers, dropout layers, pooling/up sampling layers, SoftMax layers, and the like. Example models may be a neural network, where each layer is comprised of a plurality of neurons that take a plurality of inputs, weight the inputs, input the weighted inputs into an activation function to produce an output which may then be sent to another layer. Example activation functions may include a Rectified Linear Unit (ReLu), and the like. Layers of the model may be fully or partially connected. In other examples, machine learning algorithm may be a gradient boosted tree and the model may be one or more data structures that describe the resultant nodes, leaves, edges, and the like of the tree.

In the prediction module 320, prediction feature data 390 may be input to the feature determination module 395. The prediction feature data 390 may include the data described above for the training feature data, but for a specific items such as events or impacted individuals. In some examples, the prediction module 320 may be run sequentially for one or more items. Feature determination module 395 may operate the same, or differently than feature determination module 350. In some examples, feature determination modules 350 and 395 are the same modules or different instances of the same module. Feature determination module 395 produces vector 397, which is input into the model 120 to produce predictions 399. For example, the weightings and/or network structure learned by the training module 310 may be executed on the vector 397 by applying vector 397 to a first layer of the model 120 to produce inputs to a second layer of the model 120, and so on until the prediction 399 is output. As previously noted, other data structures may be used other than a vector (e.g., a matrix).

The training module 310 may operate in an offline manner to train the model 120. The prediction module 320, however, may be designed to operate in an online manner. It should be noted that the model 120 may be periodically updated via additional training and/or user feedback. For example, additional training feature data 330 may be collected. The feedback, along with the prediction feature data 390 corresponding to that feedback, may be used to refine the model by the training module 310.

In some example embodiments, results obtained by the model 120 during operation (e.g., outputs produced by the model in response to inputs) are used to improve the training data, which is then used to generate a newer version of the model. Thus, a feedback loop is formed to use the results obtained by the model to improve the model.

The machine learning algorithm 370 may be selected from among many different potential supervised or unsupervised machine learning algorithms. Examples of learning algorithms include artificial neural networks, convolutional neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, gradient boosted tree, linear classifiers, quadratic classifiers, k-nearest neighbor, linear regression, logistic regression, a region based CNN, a full CNN (for semantic segmentation), a mask R-CNN algorithm for instance segmentation, and hidden Markov models. Examples of unsupervised learning algorithms include expectation-maximization algorithms, vector quantization, and information bottleneck method.

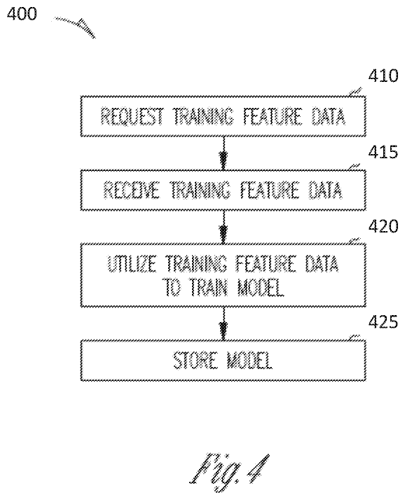

FIG. 4 illustrates a flowchart of a method 400 of training a model for a context-based life planning tool, according to various embodiments. At operation 410 the training module (e.g., training module 310 as implemented by a model system) may request training feature data, from one or more systems. At operation 415 the training module may receive the training feature data. The training feature data may be processed using more data standardization, cleanup, or other tasks such as encoding non numerical features (e.g., one hot encoding). At operation 420, the training model may use the training feature data to train the model. For example, by creating a gradient boosted tree, neural network, or the like. At operation 425 the model may be stored in a storage device. In some examples in which the training operations and predictions are done on separate computing devices, the model may be transmitted to a computing device doing predictions.

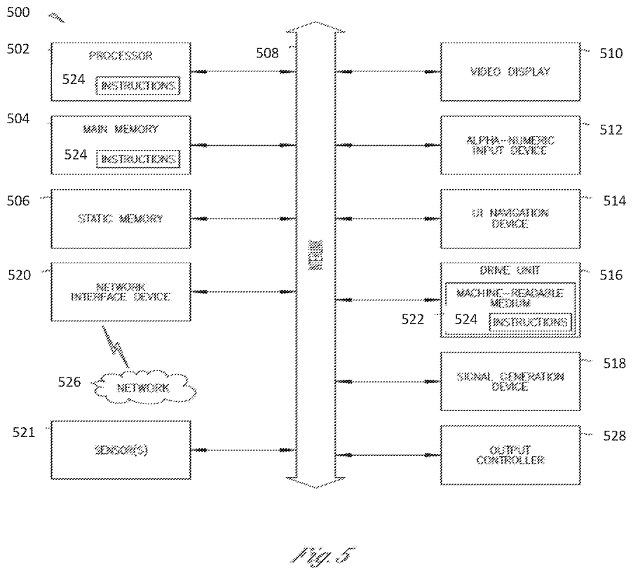

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may implement one or more of the training and prediction modules 310, 320 (e.g., as software or dedicated hardware) and may be configured to perform the methods of FIGS. 1A, 1B and 4. The machine 500 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks;

magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 524 may further be transmitted or received over a communications network 526 using a transmission medium via the network interface device 520. The Machine 500 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

### OTHER NOTES AND EXAMPLES

Example 1 is a computer-implemented method including receiving, by a computer system, information related to events that may implicate estate transfer, automatically identifying, by the computer system, one or more potentially life-threatening events using machine learning based on the information, generating, by the computer system, a casualty score for the one or more potentially life-threatening events based on the information, automatically identifying, by the computer system, one or more potentially impacted individuals of the one or more potentially life-threatening events using the machine learning, generating, by the computer system, an impact likelihood score for the one or more potentially impacted individuals based on the information, categorizing, by the computer system, the one or more potentially impacted individuals into an impact category based on the impact likelihood score, and automatically generating, by the computer system, estate transfer related action items for a financial institution advisor of the one or more potentially impacted individuals based on one or more of the impact likelihood score, the casualty score or the impact category.

In Example 2, the subject matter of Example 1 optionally includes wherein the automatically generating estate transfer related action items is based on the impact likelihood score satisfying one or more impact likelihood score thresholds.

In Example 3, the subject matter of Example 1 optionally includes wherein the automatically generating estate transfer related action items is based on calculating an aggregated casualty score for the one or more potentially life-threatening events, and wherein the aggregated casualty score for the one or more potentially life-threatening events is determined to satisfy one or more aggregated casualty score thresholds.

In Example 4, the subject matter of Example 1 optionally includes wherein the impact category includes a decease verified category.

In Example 5, the subject matter of Example 1 optionally includes wherein the impact category includes a decease non-verified category.

In Example 6, the subject matter of Example 4 optionally includes wherein the automatically generating estate transfer related action items is based on the potentially impacted individual being categorized in the decease verified category.

In Example 7, the subject matter of Example 6 optionally further includes automatically generating, by the computer system, a recommended script for the financial institution advisor to use with users associated with the impacted individual, wherein automatically generating the recommended script includes using a rule-based configuration.

In Example 8, the subject matter of Example 7 optionally includes wherein, when the impacted individual is categorized in the decease verified category, the recommended script includes context surrounding death of the impacted individual to enable the financial institution advisor to be better informed when contacting appropriate parties.

In Example 9, the subject matter of Example 7 optionally further includes determining, by the computer system, other impacted users associated with the impacted individual, and storing, by the computer system an alert or the recommended script in a profile of each of the other impacted users.

Example 10 is a system including: a computing system comprising one or more processors and a data storage system in communication with the one or more processors, wherein the data storage system comprises instructions thereon that, when executed by the one or more processors, causes the one or more processors to: receive information related to events that may implicate estate transfer; automatically identify one or more potentially life-threatening events using machine learning based on the information; generate a casualty score for the one or more potentially life-threatening events based on the information; automatically identify one or more potentially impacted individuals of the one or more potentially life-threatening events using the machine learning; generate an impact likelihood score for the one or more potentially impacted individuals based on the information; categorize the one or more potentially impacted individuals into an impact category based on the impact likelihood score; and automatically generate estate transfer related action items for a financial institution advisor of the one or more potentially impacted individuals based on one or more of the impact likelihood score, the casualty score or the impact category.

In Example 11, the subject matter of Example 10 optionally includes wherein the machine learning includes a machine learning model including a neural network.

In Example 12, the subject matter of Example 11 optionally includes wherein the neural network includes a long short-term memory (LSTM) network.

In Example 13, the subject matter of Example 10 optionally includes wherein the machine learning includes bidirectional encoder representations from transformers (BERT).

In Example 14, the subject matter of Example 10 optionally includes wherein the machine learning includes natural language processing (NLP).

In Example 15, the subject matter of Example 10 optionally includes wherein the machine learning includes an artificial intelligence (AI)-based knowledge tree.

Example 16 is a non-transitory computer-readable storage medium, the non-transitory computer-readable storage medium including instructions that, when executed by computers, cause the computers to perform operations of: receiving information related to events that may implicate estate transfer; automatically identifying one or more potentially life-threatening events using machine learning based on the information; generating a casualty score for the one or more potentially life-threatening events based on the information; automatically identifying one or more potentially impacted individuals of the one or more potentially life-threatening events using the machine learning; generating an impact likelihood score for the one or more potentially impacted individuals based on the information; categorizing the one or more potentially impacted individuals into an impact category based on the impact likelihood score; and automatically generating estate transfer related action items for a financial institution advisor of the one or more potentially impacted individuals based on one or more of the impact likelihood score, the casualty score or the impact category.

In Example 17, the subject matter of Example 16 optionally includes wherein receiving information related to events includes receiving one or more documents.

In Example 18, the subject matter of Example 17 optionally includes wherein the non-transitory computer-readable storage medium further includes instructions that, when executed by computers, cause the computers to perform operations of: identifying one or more critical terms contained within the one or more documents.

In Example 19, the subject matter of Example 18 optionally includes wherein the non-transitory computer-readable storage medium further includes instructions that, when executed by computers, cause the computers to perform operations of: determining an overall casualty score for the one or more documents based at least in part on the one or more critical terms.

In Example 20, the subject matter of Example 18 optionally includes wherein the non-transitory computer-readable storage medium further includes instructions that, when executed by computers, cause the computers to perform operations of: determining an overall casualty score for the one or more documents based at least in part on a sequence of the one or more critical terms.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A computer-implemented method comprising:
receiving, by a computer system, information related to events from external third-party data sources and internal user profile data sources, wherein the information from the external third-party data sources includes documents that may implicate estate transfer;
automatically processing, by the computer system, the documents to identify critical terms contained within the documents and determining a proximity relationship between the critical terms within the documents:
automatically identifying, by the computer system, one or more potentially life-threatening events using machine learning based on the information, wherein using the machine learning includes using a trained machine learning model with closed loop feedback training;
generating, by the computer system, a casualty score for the one or more potentially life-threatening events based on the critical terms and the proximity relationship between the critical terms information;
automatically correlating, by the computer system, the one or more potentially life-threatening events with user profile data from the internal user profile data sources:
automatically identifying, by the computer system, one or more potentially impacted individuals of the one or more potentially life-threatening events using the trained machine learning model based on the automatic correlating;
generating, by the computer system, an impact likelihood score for the one or more potentially impacted individuals based on the automatic correlating information;
categorizing, by the computer system, the one or more potentially impacted individuals into an impact category based on the impact likelihood score;
automatically generating, by the computer system, estate transfer related action items and a context-based, personalized script for a financial institution advisor of the one or more potentially impacted individuals based on one or more of the impact likelihood score, the casualty score or the impact category;
automatically performing, by the computer system, proactive measures related to estate planning to protect the one or more potentially impacted individuals, based on one or more of the impact likelihood score, the casualty score or the impact category; and
automatically updating, by the computer system, the trained machine learning model based on verification feedback from the one or more potentially impacted individuals to improve future predictions.

2. The computer-implemented method of claim 1, wherein the automatically generating estate transfer related action items is based on the impact likelihood score satisfying one or more impact likelihood score thresholds.

3. The computer-implemented method of claim 1, wherein the automatically generating estate transfer related action items is based on calculating an aggregated casualty score for the one or more potentially life-threatening events, and wherein the aggregated casualty score for the one or more potentially life-threatening events is determined to satisfy one or more aggregated casualty score thresholds.

4. The computer-implemented method of claim 1, wherein the impact category includes a decease verified category.

5. The computer-implemented method of claim 1, wherein the impact category includes a decease non-verified category.

6. The computer-implemented method of claim 4, wherein the automatically generating estate transfer related action items is based on the potentially impacted individual being categorized in the decease verified category.

7. The computer-implemented method of claim 6, further comprising:
automatically generating, by the computer system, a recommended script for the financial institution advisor to use with users associated with the impacted individual, wherein automatically generating the recommended script includes using a rule-based configuration.

8. The computer-implemented method of claim 7, wherein, when the impacted individual is categorized in the decease verified category, the recommended script includes context surrounding death of the impacted individual to enable the financial institution advisor to be better informed when contacting appropriate parties.

9. The computer-implemented method of claim 7, further comprising:
determining, by the computer system, other impacted users associated with the impacted individual; and
storing, by the computer system an alert or the recommended script in a profile of each of the other impacted users.

10. A system comprising:
a computing system comprising one or more processors and a data storage system in communication with the one or more processors, wherein the data storage system comprises instructions thereon that, when executed by the one or more processors, causes the one or more processors to:
receive information related to events from external third-party data sources and internal user profile data sources, wherein the information from the external third-party data sources includes documents that may implicate estate transfer;
automatically process the documents to identify critical terms contained within the documents and determining a proximity relationship between the critical terms within the documents;
automatically identify one or more potentially life-threatening events using machine learning based on the information, wherein using the machine learning includes using a trained machine learning model with closed loop feedback training;
generate a casualty score for the one or more potentially life-threatening events based on the critical terms and the proximity relationship between the critical terms information;
automatically correlate the one or more potentially life-threatening events with user profile data from the internal user profile data sources;
automatically identify one or more potentially impacted individuals of the one or more potentially life-threatening events using the trained machine learning model based on the automatic correlating;
generate an impact likelihood score for the one or more potentially impacted individuals based on the automatic correlating information;
categorize the one or more potentially impacted individuals into an impact category based on the impact likelihood score;
automatically generate estate transfer related action items and a context-based, personalized script for a financial institution advisor of the one or more potentially impacted individuals based on one or more of the impact likelihood score, the casualty score or the impact category;
automatically perform proactive measures related to estate planning to protect the one or more potentially impacted individuals, based on one or more of the impact likelihood score, the casualty score or the impact category; and
automatically update the trained machine learning model based on verification feedback from the one or more potentially impacted individuals to improve future predictions.

11. The system of claim 10, wherein the machine learning includes a machine learning model including a neural network.

12. The system of claim 11, wherein the neural network includes a long short-term memory (LSTM) network.

13. The system of claim 10, wherein the machine learning includes bidirectional encoder representations from transformers (BERT).

14. The system of claim 10, wherein the machine learning includes natural language processing (NLP).

15. The system of claim 10, wherein the machine learning includes an artificial intelligence (AI)-based knowledge tree.

16. A non-transitory computer-readable storage medium, the non-transitory computer-readable storage medium including instructions that, when executed by computers, cause the computers to perform operations of:
receiving information related to events from external third-party data sources and internal user profile data sources, wherein the information from the external third-party data sources includes documents that may implicate estate transfer;
automatically processing the documents to identify critical terms contained within the documents and determining a proximity relationship between the critical terms within the documents;
automatically identifying one or more potentially life-threatening events using machine learning based on the information, wherein using the machine learning includes using a trained machine learning model with closed loop feedback training;
generating a casualty score for the one or more potentially life-threatening events based on the critical terms and the proximity relationship between the critical terms information;
automatically correlating the one or more potentially life-threatening events with user profile data from the internal user profile data sources;
automatically identifying one or more potentially impacted individuals of the one or more potentially life-threatening events using the trained machine learning model based on the automatic correlating;
generating an impact likelihood score for the one or more potentially impacted individuals based on the automatic correlating information;
categorizing the one or more potentially impacted individuals into an impact category based on the impact likelihood score;
automatically generating estate transfer related action items and a context-based, personalized script for a financial institution advisor of the one or more potentially impacted individuals based on one or more of the impact likelihood score, the casualty score or the impact category;
automatically performing proactive measures related to estate planning to protect the one or more potentially impacted individuals, based on one or more of the impact likelihood score, the casualty score or the impact category; and
automatically updating the trained machine learning model based on verification feedback from the one or more potentially impacted individuals to improve future predictions.

17. The non-transitory computer-readable storage medium of claim 16, wherein receiving information related to events includes receiving one or more documents.

18. The non-transitory computer-readable storage medium of claim 17, wherein the non-transitory computer-readable storage medium further includes instructions that, when executed by computers, cause the computers to perform operations of:
identifying one or more critical terms contained within the one or more documents.

19. The non-transitory computer-readable storage medium of claim 18, wherein the non-transitory computer-readable storage medium further includes instructions that, when executed by computers, cause the computers to perform operations of:
determining an overall casualty score for the one or more documents based at least in part on the one or more critical terms.

20. The non-transitory computer-readable storage medium of claim 18, wherein the non-transitory computer-readable storage medium further includes instructions that, when executed by computers, cause the computers to perform operations of:
determining an overall casualty score for the one or more documents based at least in part on a sequence of the one or more critical terms.
